(19) United States
(12) Patent Application Publication
(10) Pub. No.: US 2017/0074256 A1
(43) Pub. Date: Mar. 16, 2017

(54) Bi-Metallic Solar Water Filtration Pump

(71) Applicant: William Banko, Armonk, NY (US)

(72) Inventor: William Banko, Armonk, NY (US)

(21) Appl. No.: 14/856,296

(22) Filed: Sep. 16, 2015

(51) Int. Cl. F04B 17/00; H02K 7/18; H02K 7/06

(52) U.S. Cl. CPC F04B 17/006; H02K 7/06; H02K 7/1807

(57) ABSTRACT

A pump uses solar energy to heat bimetals and other materials with high expansion coefficients to create movement that is coupled to pistons or impellers resulting in a fluid pumping action. The moving pistons or impellers are used to push salt water (or any fluid) through a membrane for filtration. Furthermore, the mechanical movement, powered by solar energy can be used for a variety of applications including pumps to move liquids or gases.

### FIELD OF THE INVENTION

The present invention relates to the use of solar energy to desalinate sea water.

### BACKGROUND OF THE INVENTION

Global fresh water shortages are affecting not only people's health, but regional economies and politics. Nearly two million children die annually from lack of access to fresh drinking water and it is estimated that by 2025 almost two billion people will live in areas where water is scarce. Although the Earth's seawater is abundant, freshwater represents less than 3% of the Earth's total water. Several processes are available to filter seawater in order to obtain freshwater. In one such process salt water is forced through a semi-permeable filter (e.g., a polymer membrane), which results in freshwater exiting the filter, leaving behind the salt and impurities. This process is called reverse osmosis, and it requires significant energy. Reverse osmosis is used by large-scale desalination facilities around the world that rely on nuclear power to provide the energy.

Solar energy is usually abundant in climates that are very dry and lack water. Therefore, using the sun's energy to effect desalination would be very efficient.

Most materials expand when they are heated and contract when they are cooled. However, there are materials that do the opposite and contract in certain directions as they heated and expand when they are cooled. These are called negative thermal expansion materials and include such materials as graphene, beta-quarts and some zeolites. During daylight the sun can heat most materials causing them to expand and at night when the temperatures are lower they contract. The opposite occurs with negative thermal expansion materials. With the heating during the day and the cooling at night the types of materials will continuously cycle between expanding and contracting. Expanding or contracting materials can also be cooled by a variety of methods for example artificial shade provided by canopies or cooling fluids. When materials are cooled artificially they increase the rate of the expanding or contracting cycle that now does not have to depend on only the natural cooling during nighttime.

When two metals having dissimilar thermal expansion coefficients are bound together, they result in a bi-metal strip that bends in one direction with heat and straightens or bends in the other direction as it cools. The bending of strips of brass and steel are used to measure temperature in thermostats.

### SUMMARY OF THE INVENTION

The present invention relates to the use of solar energy to heat bi-metals and other materials with high absolute or differential heat expansion coefficients that are coupled to pistons or impellers that in turn are used to force sea water through semipermeable (filtration) membranes to achieve desalinization.

In accordance with the invention a piston or impeller is moved by a mechanical coupling connected to a material that expands (or contracts) when exposed to radiant heat from sunlight. Various materials, metals and alloys have different expansion rates depending on their internal properties. With this invention solar energy is used to heat a conventional material structure resulting in an expansion of the structure. The expanding structure results in movement. This movement can be coupled to one or more pistons (or impellers) that are used to pump fresh or salt water as well as pressurize a container of saltwater or contaminated water in order to push the saltwater or contaminated water through a semipermeable membrane to desalinate or clean it.

In the evening the metal cools and the expansion of the metal is replaced with a contraction. During this period the desalination can be stopped. However, in an alternative design the contracting metal also pushes salt water through a second membrane.

The invention can be used for desalination of saltwater as well as filtration of any type of fluid. In addition the same process of moving pistons or impellers by thermal expansion of metals or other materials by using solar energy can be used to pump saltwater and fresh water to and from the desalination plant. Furthermore, the use of this process can be the basis of pumps used to move any type of liquid or gas. For example, oil refineries may use solar pumps for moving crude oil or refined petroleum products. In addition the mechanical movement necessary to power a generator that procures electricity can be provided by the expansion and contraction of materials with high thermal expansion rates and sunlight. In order to produce sufficient movement the actual motion may need to be amplified, e.g., with a gear chain.

When the present invention is used with single structure metals, the expansion and contraction is along the axis of the metal. However, an additional feature of the invention is to use bimetals or a series of metals that have different coefficients of thermal expansion. If such metals are bonded together, when they expand at different rates, the structure tends to bend away from the axis. This bending is an indication of temperature when bi-metals are used in a thermostat.

The deformation of materials by positive or negative thermal expansion along the axis of the metal or by differential thermal expansion at an angle provides a mechanical force. This force can be connected to pistons or impellers and used to ultimately pump fresh or salt water through pipes and/or force the fluid through a filter.

The metals will deform during the day when sunlight is abundant and at night the metals will cool and returned to their original shape. The movement of pistons is coupled to the (movement) expansion of the metals during heating and (movement) contraction of the metals during cooling. This provides a continuous cycle of pumping water through filters.

Cooling is required to contract materials that expand when heated (or in special cases expand materials that enlarge during cooling). The cooling can be provided by lack of sunlight at night or an artificial shade provided by a movable canopy. In addition cooling can be provided by fluids that are pumped on to or around the heated elements. For example, heated, expanded bimetal discs can be cooled by fluid, which will result in the contraction of the bimetal discs at a faster rate.

### BRIEF DESCRIPTION OF THE DRAWINGS

The foregoing and other objects and advantage of the present invention will become more readily apparent upon reference to the following specification and annexed drawings in which:

FIG. 1A is an elevation view of a solar desalinization system according to the present invention with a piston against a container wall and bimetal discs contracted in the cold position, FIG. 1B is a view with the piston pushed all the way into the chamber next to a filter and with the bimetal discs expanded in the heated position, and FIG. 1C is a view similar to that of FIG. 1A, but with the bimetal discs replaced with an axially expandable thermal expansion material structure;

FIG. 2 is an elevation view of an alternative arrangement of the solar desalinization system with a second filter so that desalinization occurs both when the piston is pushed all the way in and when it is withdrawn;

FIG. 3 is an elevation view of a solar pump according to the present invention, which has the structure of FIG. 1, but without the filter so that it operates simply as a pump and not a desalinization system;

FIG. 4 is an elevation view of a solar pump as shown in FIG. 3, but with a channel to divert fluid from chamber to cool the expanded bimetal discs;

FIG. 5 is a plan view of a solar pump wherein a single set of bimetallic discs drives a plurality of pumps;

FIG. 6 is a perspective view showing an arrangement in which the linear movement of heated and cooled bi-metallic discs is converted into rotary movement to drive an impeller;

FIG. 7 is a perspective view showing an arrangement in which rotary motion as a result of the linear movement generates electricity;

FIG. 8 illustrates an alternative arrangement for the solar desalinization system of FIG. 1 wherein the filter is in the form of a semipermeable cylinder; and

FIG. 9 shows an arrangement in which linear motion of the bi-metallic structure results in the generation of electricity.

### DETAILED DESCRIPTION OF THE INVENTION

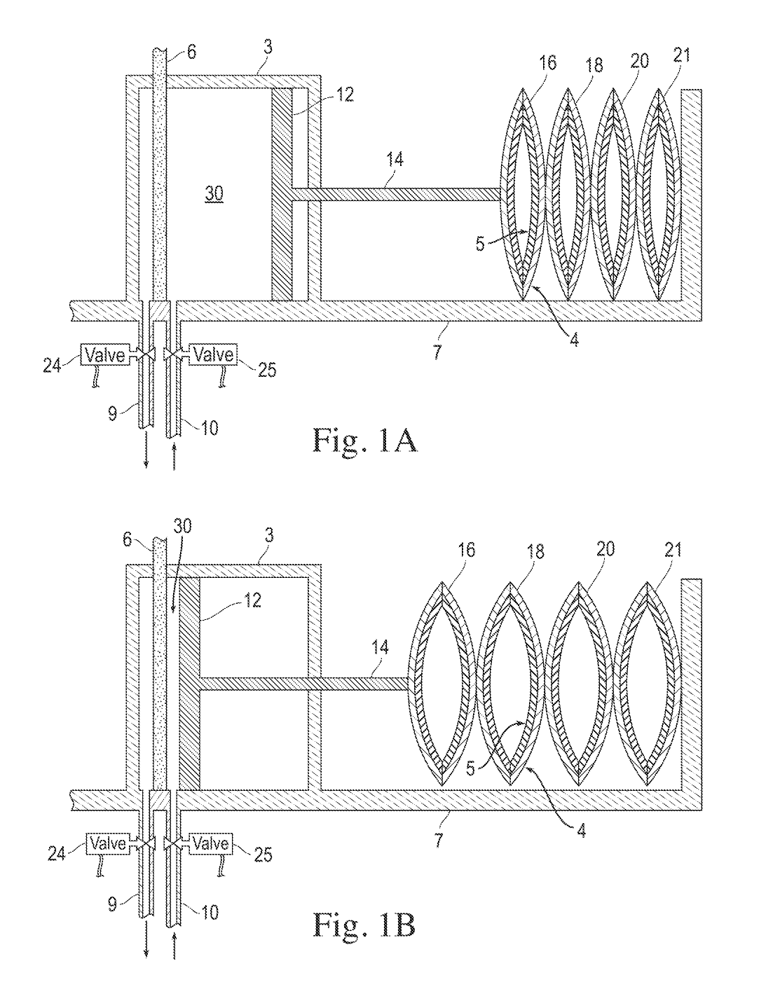

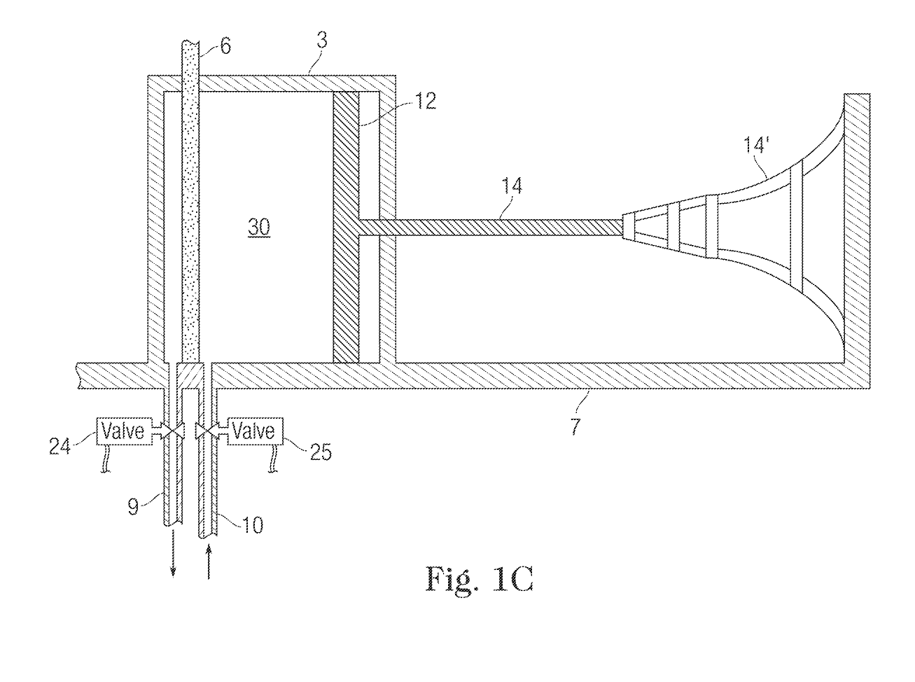

FIG. 1 shows an example of a bimetal configuration that is constructed from a series of bimetal discs 16, 18, 20, and 21. The bimetal discs are made of two metals 4 and 5 that have substantially different thermal expansion rates. Although the diagram illustrates bimetal discs, any shape that maximizes movement in the linear or rotational direction can be used in the bimetal configuration. As an alternative, a single metal bar with a high coefficient of expansion can be used in place of the discs, but it would likely have a much smaller and slower displacement. A metallic structure thermal expansion material 14′ is shown in FIG. 1C substituted for the bi-metallic discs. The tapered nature of the structure caused the pointed end to move more in the axial direction than would a straight bar.

The bimetal discs are connected to each other and to a piston 12 by shaft 14. When valve 25 is open fluid can enter a portion 30 of the interior of chamber 3 through pipe 10. After the portion 30 of the chamber is filled with fluid, valve 25 can be closed and the bimetal discs 16, 18, 20, and 21, can be exposed to sunlight and expand, thereby pushing shaft 14 and piston 12 to the left in FIG. 1A. As piston 12 is moving it is pushing fluid through a semipermeable membrane 6. As this occurs, valve 24 must be open in order to allow filtered fluid to exit through pipe 9. The expansion of the discs and movement of the piston are relatively slow, but they can have great force. If the structures in FIG. 1 are relatively large, even with the slow movement of the piston, a large quantity of salt water can be desalinated. FIG. 1B shows the discs in their fully expanded condition and with the piston 12 pushed against the membrane 6.

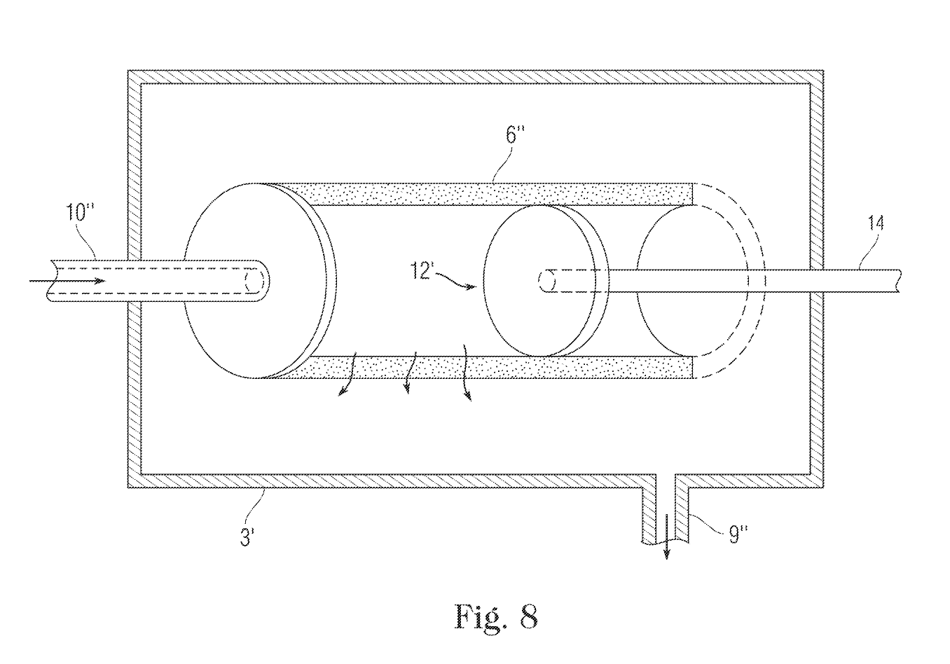

FIG. 1 shows one possible configuration with the semipermeable membrane 6 being removable from chamber 3. As a result, semi permeable membrane 6 can be replaced with a new membrane when required. However any possible configuration of having a piston or pistons pushed by bi-metals can be implemented. For example as shown in FIG. 8, bimetal structures can push a piston 12′ into a cylindrical permeable membrane 6″ where the entire cylinder is made of semipermeable membrane. The cylindrical semi permeable membrane can then be located in an appropriate housing or chamber 3′. With this arrangement a large surface of the membrane is exposed and used in the desalinization process. In particular, salt water can enter the interior of the cylinder 6″ through pipe 10″ as piston 12″ is withdrawn to the right in FIG. 8. After being fully retracted, a valve on pipe 10″ is closed and the piston is pushed into the cylinder due to some form of thermal expansion. As this occurs, the salt water is forced through the cylinder in all directions. The fresh or filter water exits the housing 3′ through pipe 9″.

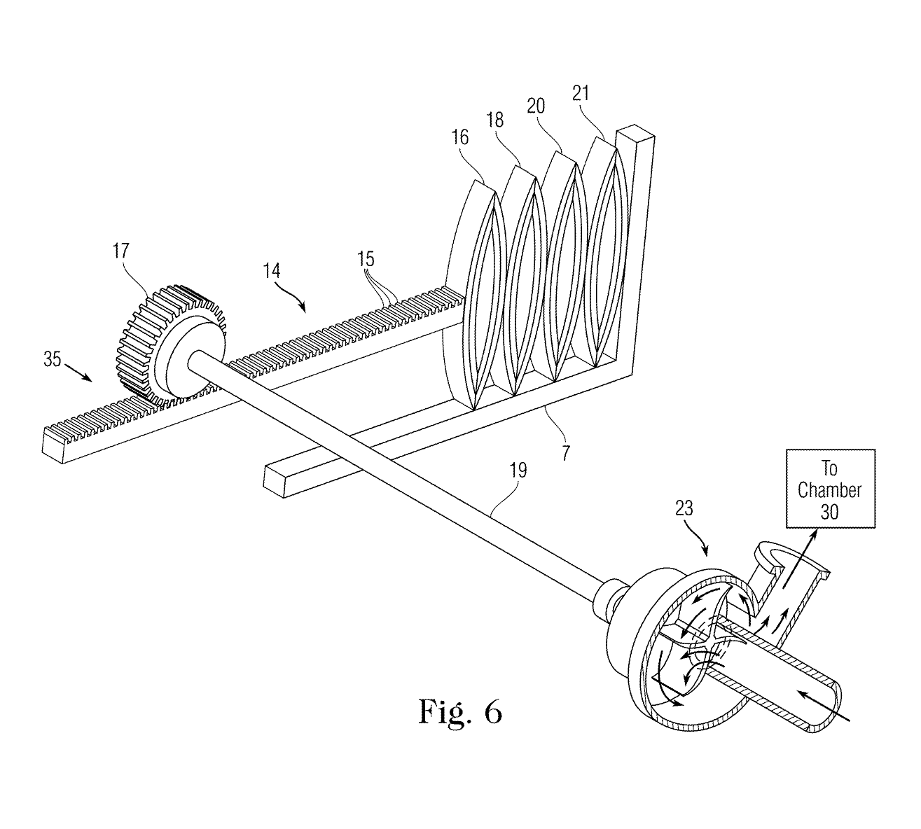

Although FIG. 1 shows a pump using at least one piston to pump fluid or gas, the thermal expansion and movement of shaft 14 can also be coupled to an impeller type of mechanism (or any mechanism that is designed to move fluids or gases and requires a mechanical force) as shown in FIG. 6, and is not limited to moving fluids or gases by pistons. For the impeller to operate a mechanism is required that converts linear movement into rotary movement. FIG. 6 shows such an arrangement using a rack-and-pinion mechanism to generate the rotary motion. As the shaft 14 moves, the teeth 15 on the rack move. This movement causes pinion 17 to turn, which results in the turning of a shaft 19 that drives impeller 23. The rotating blades of the impeller 23 can provide the fluid to the portion 30 of the chamber 3 shown in FIG. 1. The force of this fluid can cause it to move against and through the membrane 6 in the chamber 3, even without the aid of the moving piston 12.

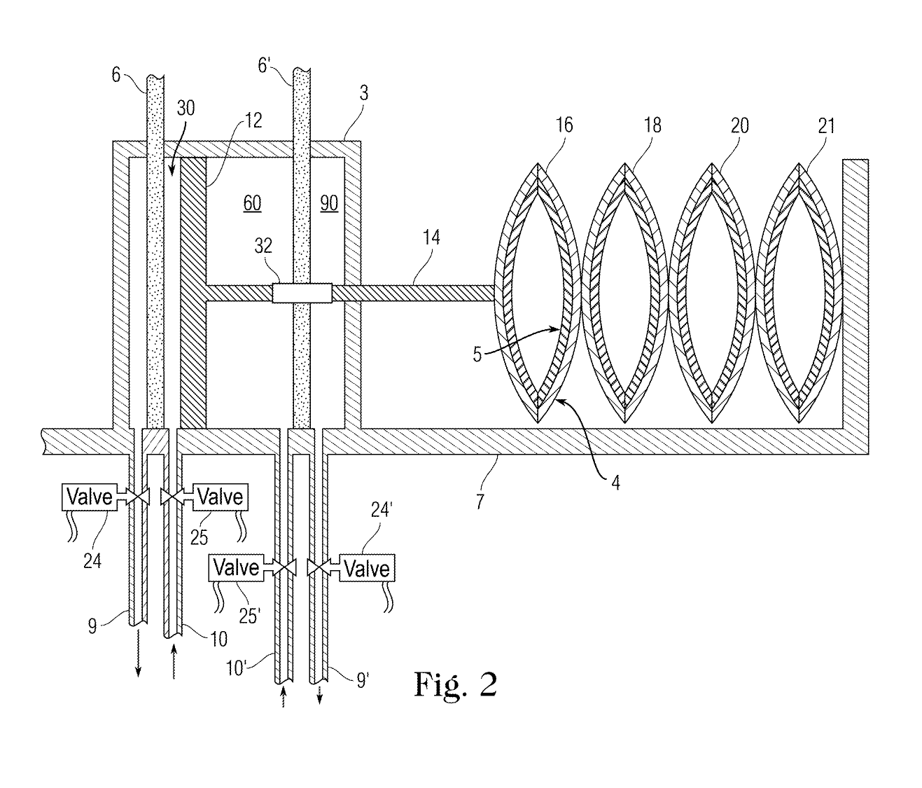

FIG. 1B shows the bimetal discs 16, 18, 20, and 21, expanded by heat from sunlight so that shaft 14 and piston 12 are pushed all the way into container 3. This results in the fluid contents being forced through the semi permeable membrane 6 and filtered fluid passing out of open valve 24 and pipe 9. As daylight ends the discs begin to cool and contract. At that point the desalinization could stop for the day. However, if chamber 3 is provided with another membrane 6′ as shown in FIG. 2, the contraction of the discs and movement of the piston back to its original position could force fluid through it into a portion 90 within chamber 3. This could create fresh water that could enter tube 9′ if valve 24′ is opened and thus continue the process at night. In such a case the fluid enters a region 60 which is behind the piston. Note that the portion 30 of the chamber has been reduced to the area between the front of the piston and the membrane 6.

With the arrangement in FIG. 2, a valve 25′ is opened as the piston moves to the left in FIG. 2 to fill the portion 60 with salt water. As the piston moves back, that valve is closed and valve 24′ is opened to remove the fresh water from portion 90. At the same time valve 25 is opened to allow salt water to enter the portion 30 at the front of the piston as it moves to the right. The valve 24 would then be closed.

It should be noted that with this arrangement the shaft 14 passes through the membrane 6′. This needs to occur through a water tight passage 32 in order to prevent the mixing of the salt and fresh water.

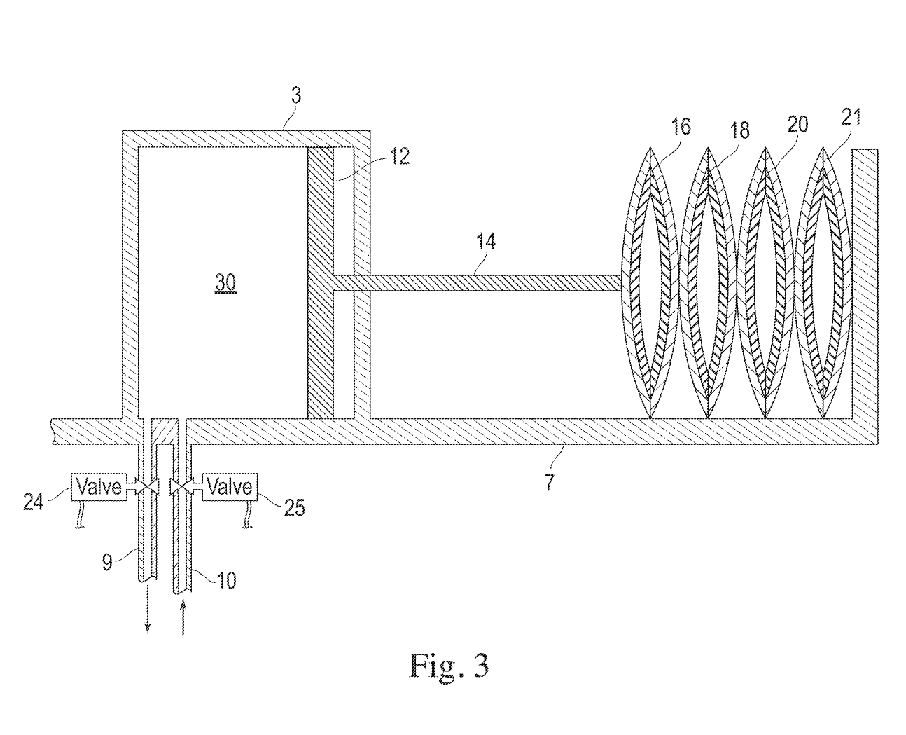

FIG. 3 shows a bimetal configuration of a pump that can be used to pump fluids or gases. Note that as compared to FIGS. 1 and 2, the membrane 6 has been removed. In FIG. 3, chamber 3 is filled with a fluid or a gas entering through pipe 10 when valve 25 is open and valve 24 is closed. The fluid or gas can now be pushed out of the chamber 3 when valve 25 is closed through open valve 24 and pipe 9, when the bimetal discs are exposed to sunlight. The expansion of the bimetal discs and movement of shaft 14 and piston 12 will push out the gas or fluid from the portion 30 of the chamber 3 through valve 24 into pipe 9.

When all the fluids or gas are pushed out of portion 30 in container 3, the bimetal discs can be cooled and shaft 14 and piston 12 can then pull gases or fluids from pipe 10 when valve 25 is open and valve 24 is closed, thus refilling the portion 30 with fluid or gas. This repetitive cycle results in a pumping action for fluids and gases. Valve 25 is closed when portion 30 is filled and valve 24 can be opened and the bimetal disc can be exposed to heat to pump out the contents.

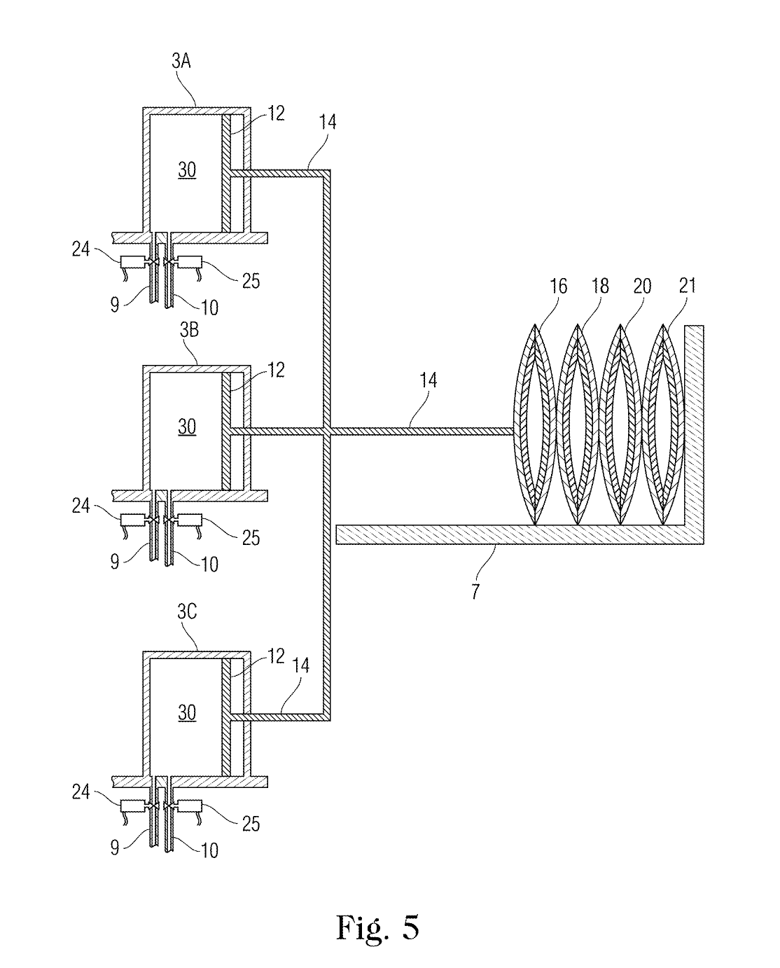

FIG. 3 shows a pump using a single piston to pump fluid or gas. However, a single set discs driving shaft 14 can be used to power a series of parallel pumps 3A, 3B, and 3C as shown in FIG. 5. In addition the multiple pumps can have a series configuration.

The pump described in FIG. 3 (non-filtering) can be used to pump fluid (saltwater) to another filtering pump such as that shown in FIG. 3. Also, the pump can be sued to distribute fresh or filtered water from chamber 3 to where it is needed.

In addition to providing fluid (that requires filtration) to the filtering pump, a pump described and shown in FIG. 3 can be used to provide cooling fluid to a filtering pump that will cool the expanded elements and bring them to the contracted position.

The filtering pump in FIG. 2 has the bimetals expanded and the fluids pushed out of portion 30 in container 3. This means that the bimetal discs need to be cooled in order to retract shaft 14 and piston 12. The cooling can be done by decreasing the sunlight at night or artificially shading the bimetal discs or using fluid to cool the bimetal discs. Fluid used to cool the bimetal discs can be provided by the pump described and shown in FIG. 3.

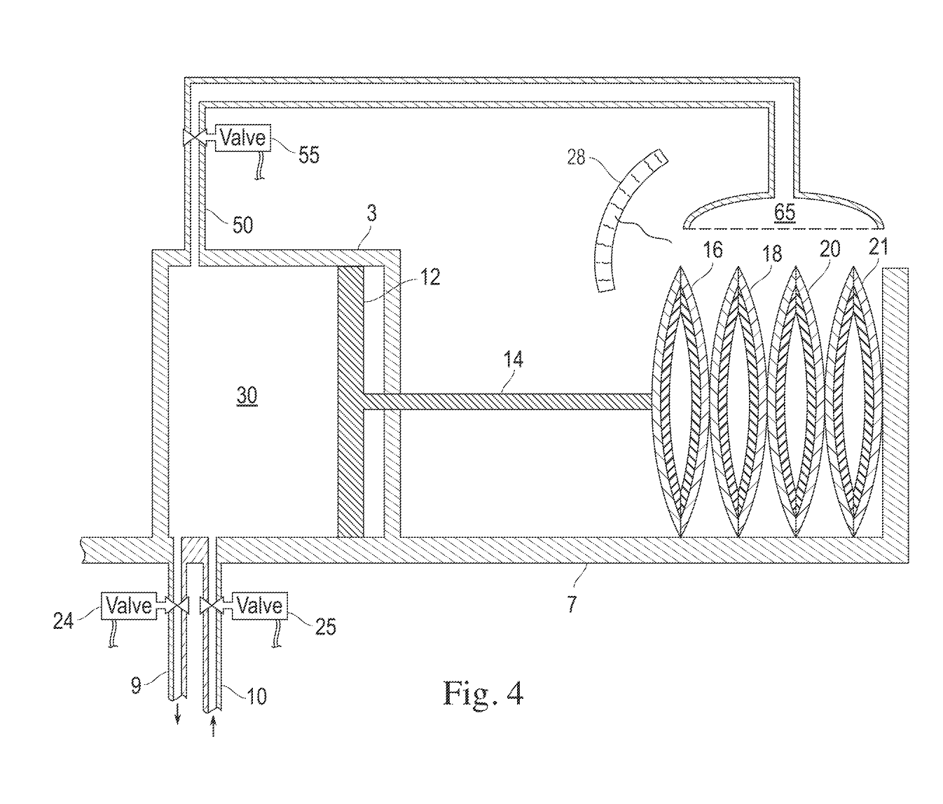

FIG. 4 illustrates such a cooling mechanism as an integral part of the pump. Piston 12 is shown against the wall of container 3 and in position to push the fluid or gas in portion 30 out of container 3 when the bimetal discs are expanded by exposure to sunlight. As the bimetal discs are approaching maximum expansion, valve 55 can be open so fluid can enter pipe 50 and pass into chamber 65. Chamber 65 can not only act as a cooling fluid provider for the discs, but also as a movable shade for the discs. Thus the fluid released from chamber 65 and the shade it provides can cool down the bimetal discs. However, fluid can be provided only while the piston is still moving in the heat expansion direction. As contraction begins as a result of the fluid and shade from chamber 65, shaft 14 and piston 12 will move towards the bimetal discs and as a result piston 12 will stop providing fluid to chamber 65 and will start drawing fluid or gas from pipe 10 when valve 25 is open and valves 24 and 55 are closed. If the shaft 14 moves fast enough that the piston is near the end of its travel away from the discs during only a part of the day and the contraction is due to the fluid and shade from chamber 65, as opposed to sunset, the pumping cycle can then begin again by exposing the bimetal discs to the sun again so they expand. Thus a pumping cycle that is more frequent than the sun cycle is possible.

Although FIGS. 1A, 1B, 2, 3, 4 and 5, illustrate expansion due to bimetals, any type of material that has a high thermal expansion rate, whether due to heating or cooling, can be used to power shaft 14 and piston 12 in order to filter or pump fluids and gases. See for example FIG. 1C.

The amount of sunlight (and heat) provided to expanding materials can be amplified by using reflective surfaces, e.g., reflector 28 in FIG. 4, that focus and concentrate sunlight on materials (e.g., the discs) that expand when heated. Parabolic reflective surfaces on structure 28 focus sunlight on the discs to maximize the heat transfer that expands the discs. If structure 28 is made movable, it can move the focal point on the discs during part of the cycle and can move the focused beam away from the discs during a cooling cycle, which would result in efficiently cycling of the expansion and contraction of the materials that provide movement to the solar pump.

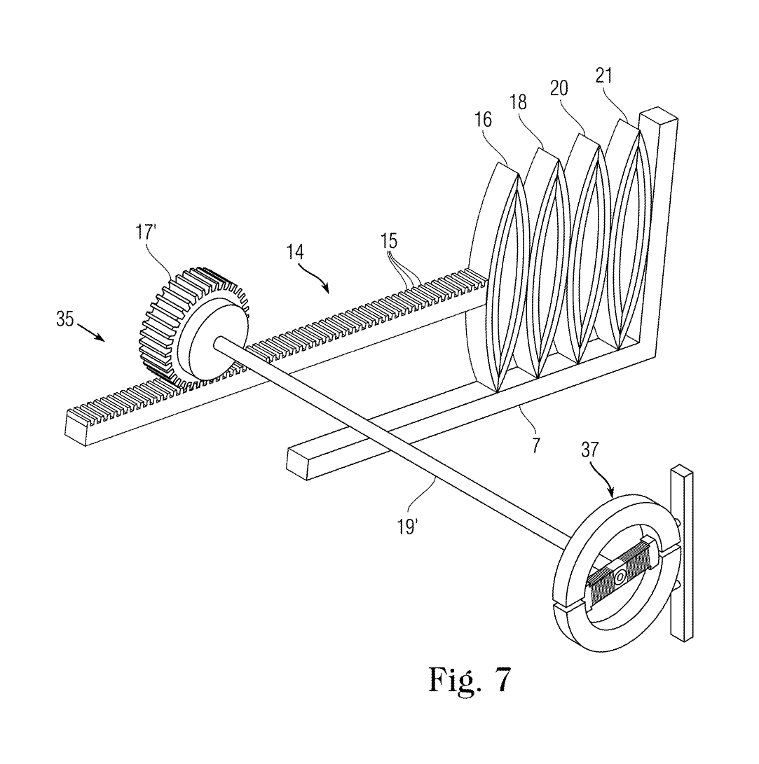

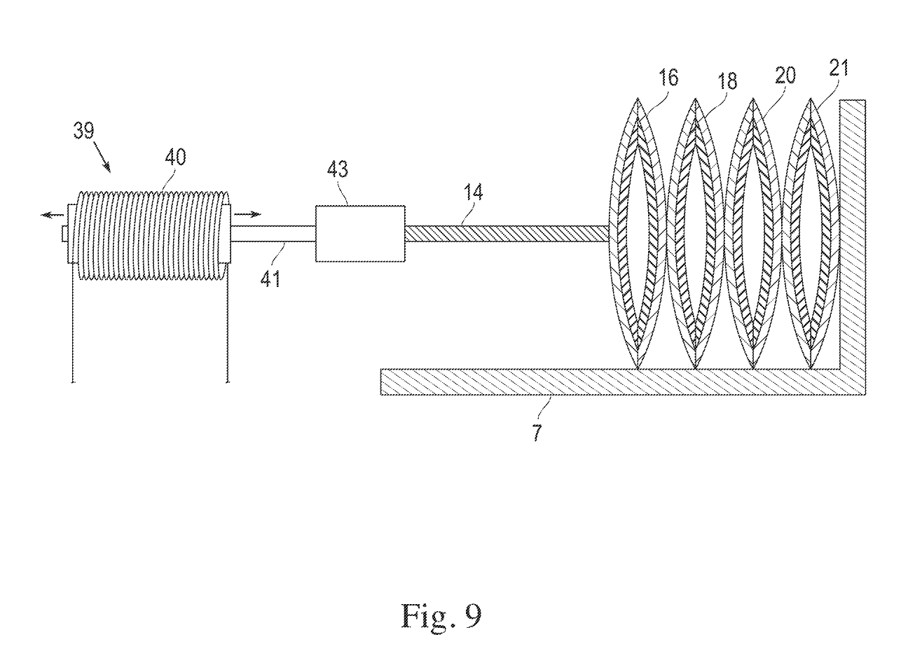

Electrical generators can produce electricity by converting mechanical energy into electrical energy. The source of mechanical energy for an electric generator can be the motion of a shaft or connecting rod that is connected to a thermal expansive structure or bimetal structure designed to expand when heated by sunlight as shown in FIG. 7. The movement resulting from expansion ultimately moves the shaft or connecting rod 14 that provides the mechanical energy required by electric generators to produce electricity. However, in order to generate electricity, typically a faster speed is required than the expansion speed of the present invention. Also, typically a rotary motion is needed, but linear generators as shown in FIG. 9 can also be used.

As shown in FIG. 7 a higher speed rotary motion is accomplished by a rack-and-pinion arrangement 35, which is similar to that in FIG. 6. However, the pinion 17′ in this arrangement has a step up gear ratio so that the slow movement of the shaft 14 is converted into a much faster rotation of shaft 19′. The shaft 19′ drives an electrical generator 37 that produces electricity. This electricity can be used to power the opening and closing of values in the desalinization plant or if there is excess electricity, it can be provided to the power grid.

In FIG. 9 a linear electrical generator is shown. It includes a tightly wound coil 40 and a shaft 41 with a series of magnets. As the magnets are moved through the coil, electricity is generated in the coils. In order to move the shaft 41, the bi-metallic discs 16, 18, 20 and 21 are connected to shaft 14 as shown in FIG. 1. However, in generating electricity, it is helpful to have more speed than is produced by the discs. The extra speed is provided by a transmission 43 that amplifies the rate of motion of shaft 14 and applies it to shaft 41.

The elements of the embodiments described above can be combined to provide further embodiments. These and other changes can be made to the system in light of the above detailed description. While the invention has been particularly shown and described herein, with reference to preferred embodiments thereof, it will be understood by those skilled in the art that various changes in form and details may be made therein without departing from the spirit and scope of the invention.

I claim:

1. A thermal pump comprising:
a thermal expansion material structure that expands or contracts as a result of the application or removal of heat;
a hollow chamber, an end of said structure slidably extending through a near wall of said chamber in a fluid tight manner;
a piston within the chamber being connected to the end of said structure, said piston being slidable in said chamber in a first direction when the structure expands and substantially separating portions of said chamber before and after said piston;
a fluid inlet for substantially filling said chamber with fluid; and
a fluid outlet,
whereby expansion of the structure causes the piston to move in the chamber in the first direction and to push fluid in the chamber toward the outlet.

2. The thermal pump of claim 1 wherein the thermal expansion material structure is made of a bi-metallic material that expands when heated and contracts when cooled; said bi-metallic material being formed from at least two metals with different thermal expansion rates, said bi-metallic material being located between a stationary structure and said piston, said bi-metallic material increasing the motion of the piston with heating and cooling.

3. The thermal pump of claim 2 wherein upon cooling of bi-metallic material, the piston moves in a second direction toward the stationary structure, and as a result draws fluid into the chamber from the fluid inlet.

4. The thermal pump of claim 2 wherein the thermal expansion material structure comprises a plurality of bi-metallic discs stacked in series with one end connected to the stationary structure, and a shaft extending from the other end of the series of discs to the piston within the chamber.

5. The thermal pump of claim 1 wherein the thermal expansion material structure is a metal structure with conical sections that decrease in size and are connected in series.

6. The thermal pump of claim 1 wherein the fluid inlet and outlet are toward a wall of the chamber opposite and remote from the wall through which the structure extends, the fluid outlet being the most remote, and
further comprising a semipermeable membrane between the fluid outlet and inlet extending across the chamber to form a first portion between the membrane and the remote end wall with the outlet contained therein and a second portion between the membrane and the wall through which the structure extends, said piston being located in the second portion, said membrane being of a material such that when a fluid in the second portion contains salt water and said piston moves toward said membrane, the membrane filters out the salt and desalinates the fluid in the chamber so that fresh or filtered water is created in the first chamber and may exit the chamber through the outlet.

7. The thermal pump of claim 6 wherein the thermal expansion material structure is made of a bi-metallic material that expands when heated and contracts when cooled; said bi-metallic material being formed from at least two metals with different thermal expansion rates, said bi-metallic material being located between a stationary structure and said piston, said bi-metallic material increasing the motion of the piston with heating and cooling.

8. The thermal pump of claim 7 wherein the thermal expansion material structure comprises a plurality of bi-metallic discs stacked in series with one end connected to the stationary structure, and a metal shaft extending from the other end of the series of discs to the piston within the chamber.

9. The thermal pump of claim 7 wherein the thermal expansion material structure is a metal structure with conical sections that decrease in size and are connected in series.

10. The thermal pump of claim 6, wherein a slot is provided in a wall of the chamber so that the membrane can be removed and replaced with a fresh one.

11. The thermal pump of claim 6 wherein the fluid inlet further comprises a valve and the fluid outlet further comprises a valve, and wherein when the piston is moving toward the membrane the inlet valve is closed and the outlet valve is open, and when the piston is moving away from the membrane the outlet valve is closed and the inlet valve is open so as to draw fluid into the chamber, whereby the pump cycles with the addition and removal of heat.

12. The thermal pump of claim 1 wherein the applied heat is due to exposure to the sun.

13. The thermal pump of claim 2 wherein the applied heat is due to exposure to the sun.

14. The thermal pump of claim 1 further comprising apparatus for expediting the removal of heat from the structure.

15. The thermal pump of claim 2 further comprising apparatus for expediting the removal of heat from the bi-metallic material.

16. The thermal pump of claim 12 wherein the applied heat is due to exposure to the sun and the apparatus for removal of heat is a shade located over the structure.

17. The thermal pump of claim 13 wherein the applied heat is due to exposure to the sun and the apparatus for removal of heat is a shade located over the bi-metallic material.

18. The thermal pump of claim 16 wherein the apparatus for removal of heat comprises pipes for providing cooling liquid on the structure.

19. The thermal pump of claim 17 wherein the apparatus for removal of heat comprises pipes for providing cooling liquid on the bi-metallic material.

20. The thermal pump of claim 18 wherein the cooling water is recycled from the chamber through a valve.

21. The thermal pump of claim 19 wherein the cooling water is recycled from the chamber through a valve.

22. The thermal pump of claim 12 further including reflectors for reflecting sun light onto the bar such that heating of the structure is expedited.

23. The thermal pump of claim 13 further including reflectors for reflecting sun light onto the bar such that heating of the bi-metallic material is expedited.

24. The thermal pump of claim 6 further comprising
a second fluid inlet and a second fluid outlet located adjacent the near wall through which the structure extends with the second outlet closest to the near wall,
a second semipermeable membrane between the second fluid outlet and the second fluid inlet, said second semipermeable membrane extending across the chamber to form a third portion between the second membrane and the near wall with the second fluid outlet contained therein; and
wherein the second portion between the membrane and the second membrane has said piston located therein, said second membrane being of a material such that when the second portion contains salt water and said piston moves toward said second membrane, the second membrane filters out the salt and desalinates the fluid in the chamber so that fresh water is created in the third chamber and may exit the third chamber thought the outlet;
whereby the pump desalinates water both when the structure is heated and when it is cooled.

25. The thermal pump of claim 1 further including a plurality of chambers each with a piston connected to said structure so as to multiply the rate of pumping.

26. The thermal pump of claim 2 further including a plurality of chambers each with a piston connected to said bi-metallic material so as to multiply the rate of pumping.

27. The thermal pump of claim 6 further including a plurality of chambers each with a piston connected to said structure so as to multiply the rate of desalinization.

28. The thermal pump of claim 7 further including a plurality of chambers each with a piston connected to said bi-metallic material so as to multiply the rate of desalinization

29. The thermal pump of claim 1 wherein the thermal expansion material structure is made of a metallic structure that expands when cools and contracts when heated.

30. A thermal pump comprising:
a thermal expansion material structure that expands or contracts as a result of the application or removal of heat;
a rack connected to the structure so as to move linearly as the structure expands and contracts;
a pinion connected to the rack so as to rotate with the linear motion of the rack;
an impeller connected to an a shaft of the pinon;
whereby the impeller moves fluid based on the expansion and contraction.

31. An electrical generator comprising:
a thermal expansion material structure that expands or contracts as a result of the application or removal of heat;
a shaft connected to the structure so as to move linearly as the structure expands and contracts; and
a gear train connected to the shaft to multiply the linear movement of the shaft; and
a linear electrical generator connected to the output of the gear train and generating electricity as a result thereof.

32. An electrical generator comprising:
a thermal expansion material structure that expands or contracts as a result of the application or removal of heat;
a rack connected to the structure so as to move linearly as the structure expands and contracts;
a pinion connected to the rack so as to rotate with the linear motion of the rack;
a gear train connected to the pinion to multiply the rotary movement at an output shaft; and
an electrical generator connected to the output shaft of the gear train and generating electricity as a result thereof.
